(19) United States
(12) Patent Application Publication
(10) Pub. No.: US 2009/0090136 A1
(43) Pub. Date: Apr. 9, 2009

(54) METHOD OF MAKING LOW-TEMPERATURE OPTICAL GLASS FIBERS FREE OF DEFECTS

(75) Inventor: Dahn C. Tran, Potomac, MD (US)

Correspondence Address: BROWDY AND NEIMARK, P.L.L.C.;624 NINTH STREET, NW, SUITE 300, WASHINGTON, DC, 20001-5303, US

(73) Assignee: INFRARED FOCAL SYSTEMS, INC., Silver Spring, MD (US)

(21) Appl. No.: 12/241,461

(22) Filed: Sep. 30, 2008

Related U.S. Application Data
(60) Provisional application No. 60/976,689, filed on Oct. 1, 2007.

(51) Int. Cl. C03B 37/023; C03C 25/10

(52) U.S. Cl. 65/404; 65/529

(57) ABSTRACT

A method of molding low-temperature glass into a preform for formation by drawing into glass fiber, especially for transmission of mid-IR, involves casting a cladding glass into a mold cavity in the shape of the desired preform to form a cladding layer, and forming a glass core within the cladding layer, wherein the molten cladding glass is drained from the bottom of the mold cavity, forming an annular coating of cladding glass as an annular layer, and the core glass is quickly added within the annular cladding layer to form the glass core with the cladding layer thereabout.

### FIELD OF INVENTION

The present invention relates to a novel method of making optical glass fibers based on low-temperature glasses such as fluoride and heavy-metal oxide glasses, including known low-temperature glasses, free or substantially free of defects such as micro-bubbles. Low-temperature glasses are those which have a low viscosity at the melt temperature.

### BACKGROUND OF THE INVENTION

Prior art related to heavy-metal oxide glasses such as GeO₂-based glasses and fibers shows that they possess high transmission in the mid-IR wavelength region, high mechanical strength, and moisture resistance¹. These characteristics allow heavy-metal oxide glass fibers to play a major role in remote sensing in the mid-IR as well as in mid-IR laser surgical applications.

Laser surgery involving mid-infrared lasers such as Er:YAG laser (2.94 micron emission) and Er:YSGG (2.79 micron emission) is evolving at a fast pace. Examples of laser surgery involving Er:YAG and ER:YSGG lasers are laser dentistry (cavity preparation, carries removal, and root canal procedure), and ophthalmology (cataract and vitreous tissue removal). Since human tissues contain water which has the highest absorption coefficient at around 3.0 microns, mid-IR lasers are very efficient in precise cutting and ablating. Presently, the most common fiber delivery system for mid-IR lasers uses a heavy-metal oxide glass fiber, preferably a Germanium Oxide (GeO₂)-based glass optical fiber as disclosed in Tran U.S. Pat. No. 5,274,728. GeO₂-based fibers have good transmission at 2.79 and 2.94 microns, are capable of handling high power and are resistant to attack from humidity.

The prior art describes two methods of making optical fibers from low temperature-glasses, described for fluoride glass fibers. The first method, termed rotational casting², consists of rotating a molten fluoride cladding glass inside a metallic mold to form a solid tube, then pouring a molten fluoride core glass melt inside the tube to form a preform. The preform is then drawn into fibers consisting of a core surrounding by the cladding glass.

The second prior method, called build-in casting³, consists of casting the clad melt inside a metallic mold and then upsetting the mold. A layer of melt solidifies around the cavity of the mold to form a cladding tube, and the inner part spills out. The core melt is then cast inside the cladding tube to form a preform.

The main problem associated with these two methods is that it takes at least 10 seconds before the core melt can be cast inside the cladding tube. In the case of rotational casting, it takes at least 10 seconds for the rotation to stop; furthermore, as the cladding melt is rotating inside the mold at around 2,000 rpm, the molten glass melt is pushed against the mold opening by centrifugal force, throwing glass debris and even loose fibers which are deposited at the opening of the mold. In this case it takes time to clear away the deposits from the mold opening before the core melt can be poured inside the cavity.

The same drawback can be seen in the build-in casting approach. Here, as the inert part of the cladding melt spills out, strands of glass fibers solidify around the opening. These glass strands must be broken off and cleared away before the core can be cast in.

The time lapses in casting the core melt in both prior art methods result in an important drop in the temperature of the cladding glass. As a result, a degree of non-wetting occurs at the core-clad interface when the hot core melt is poured in. Non-wetting refers to the incomplete fusion of the core glass and the cladding class originating from the difference in temperature, and gives rise to micro-bubbles at the core-clad interface of the preform.

Micro-bubbles at the core-clad interface of the preform remain in the resultant fiber when the preforms are drawn into fibers. Interface bubbles in the fiber can cause high scattering loss and limits the power transmission of the fiber delivery system.

### SUMMARY OF INVENTION

It is an object of the present invention to over-come defects in the prior art such as those mentioned above.

It is another object to provide an improved method of making preforms of low-temperature glasses from which improved optical glass fibers can be and are formed.

It is yet another object to provide an improved laser device for laser surgery which employs such an optical glass fiber.

It is further object of the present invention to provide an improved mold for forming such a preform.

The system of the present invention involves providing a casting mold for the preform, which casting mold permits the draining of molten cladding glass from the bottom of the mold cavity, casting the cladding glass in the mold cavity to form the cladding, draining the cladding glass from the bottom of the mold, and quickly casting the core glass within the resultant annular cladding to form the preform from which the optical glass fiber can then be drawn, the quick casting being optionally simultaneous with the draining of the cladding glass.

The following detailed description of embodiments will now further describe the invention in conjunction with the drawing, wherein:

### BRIEF DESCRIPTION OF DRAWINGS

FIG. 1 is a schematic representation of a first embodiment according to the present invention; and

FIG. 2 is a schematic representation of a second embodiment according to the present invention.

### DESCRIPTION OF PREFERRED EMBODIMENTS

The present invention provides a new method of making bubble-free low-temperature glass preforms and optical fibers from fluoride glass, GeO₂-based glass, and other low temperature glasses.

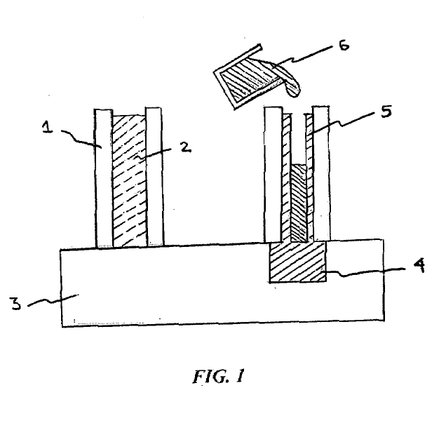

Referring to FIG. 1, the novel method, called bottom drain molding, consists of filling a metallic mold 1 which is opened at the bottom, with a cladding glass melt 2. The mold is initially positioned over a flat section of a base plate 3, but is moved immediately to a section of the base plate which has drainage well 4, forming a uniform cladding layer 5 within the cavity of the mold as the inner region of the molten cladding glass, which is still hot and fluid, is drained into the well 4.

Because of bottom draining, there is no debris or loose fibers deposited at the mold opening, allowing the core melt 6 to be cast immediately into the cladding tube which is still at an elevated temperature. The casting of the core melt, when the cladding glass is still hot, enables complete fusion or wetting between the two glasses and prevents or substantially reduces interface bubble formation.

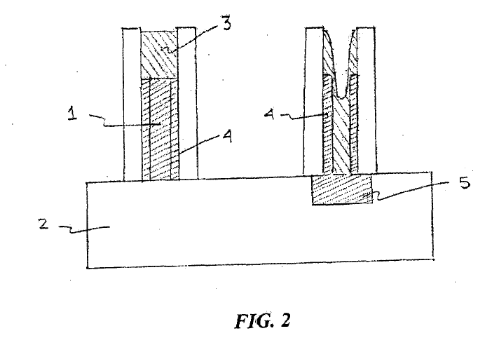

According to a variation and using the bottom drain approach, referring to FIG. 2, a low viscosity cladding melt 10 is poured inside a mold placed over a flat part of the base plate 20, as described above. A core melt 30 with higher viscosity is poured on top of the cladding melt. After forming a cladding layer 40 around the cavity of the mold, the mold is translated toward the drainage well section 50 of the base plate allowing the inner region of the cladding melt to drain into the well. The core melt will then immediately fill up the open space forming a preform structure. Again, complete or substantially complete wetting of the two glasses can be achieved with little or no interface bubbles being formed. In this later approach, the difference in viscosity between the cladding and core glass melts prevents the two glasses from mixing together.

Other means or mechanisms for initially closing the bottom of the mold, and then later opening the mold bottom to permit draining, can be used.

### EXAMPLES

### Example 1

The core and cladding glass molar compositions were 43GeO₂-57PbO and 47GeO₂-53PbO, respectively. An 11 mm ID×100 mm long brass mold pre-heated at 360° C. was placed on base plate, also pre-heated at 360° C., as shown in FIG. 1. About 60 g of cladding glass melt maintained at 950° C. was cast inside the mold. The layer of melt close to the inner wall of the mold solidified almost immediately, forming a cladding layer. The mold was then moved to a region of the base plate which had a drainage well, and the inner region of the melt which was still fluid was drained into the well, forming a cladding tube. Immediately, 25 g of core melt was poured at 950° C. inside the cladding tube, forming a preform, which was cooled slowly to room temperature at a rate of 3° C./min. to remove residual thermal stress. The preform core-clad interface was examined under a high-magnification microscope. No micro-bubbles were detected.

### Example 2

The core and cladding compositions were similar to those of Example 1. An 11 mm ID×100 mm long brass mold pre-heated at 360° C. was placed on base plate as shown in FIG. 2, also pre-heated at 360° C. About 40 g of cladding glass melt maintained at 950° C. and having a viscosity of about 1 poise, was cast inside the mold. The cladding melt filled up almost ⅔ of the mold cavity. Separately, about 25 g of core melt, maintained at around 800° C. in a platinum crucible at a viscosity of about 15 poises, was cast on top of the cladding melt to fill up the tube. The mold was immediately translated toward the drainage well section of the base plate as shown in FIG. 2, allowing the inner region of the cladding melt to drain into the well and the core melt to fill up the open inner space. The preform as obtained was cooled slowly to room temperature at a rate of 3° C./min. to remove residual thermal stress. Under examination using a high-magnification microscope, the glass preform interface was completely free of micro-bubbles.

The forgoing description of specific embodiments reveals the general nature of the invention so that others can, by applying current knowledge, readily modify and/or adapt for various applications such embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not limitation.

What is claimed is:

1. A method of molding low-temperature glass into a preform adapted for formation by drawing into fiber, comprising casting a cladding glass into a mold cavity in the shape of the desired preform to form a cladding layer, and forming a glass core within the cladding layer, the improvement comprising
draining molten cladding glass from the bottom of the mold cavity, forming an annular coating of cladding glass as an annular layer, and quickly filling a core space within the annular cladding layer with a core glass to form the glass core within the cladding layer.

2. The method of claim 1 wherein the core glass is cast into the core space inside the cladding after the cladding glass has begun to drain from the bottom of the cavity.

3. The method of claim 1 wherein the core glass has a higher viscosity than the cladding glass and is initially provided as a melt on top of the cladding glass melt prior to or simultaneous with initiating draining of the cladding glass from the bottom of the mold cavity, whereby the core glass flows into the core space simultaneous with the draining of the cladding glass.

4. The method of claim 1 wherein at least one of the cladding glass and core glass is a fluoride glass or a heavy-metal oxide glass.

5. The method according to claim 1 wherein at least one of the cladding glass and the core glass is a heavy-metal oxide glass.

6. the method according to claim 5 wherein the heavy metal oxide glass is a Germanium oxide glass.

7. The method of claim 1 further comprising drawing the preform into fiber.

8. In a laser adapted for laser surgery and comprising a glass fiber for transmission of mid-IR, the improvement wherein the glass fiber is a glass fiber made according to claim 7.

9. A mold for forming a glass preform comprising a cladding of a first glass and a core of a second glass,
said mold having a generally circular-cylindrical cavity, an open top, and an open bottom; and
a means or mechanism for closing the mold bottom during a first phase of casting of the cladding glass, and a means or mechanism for opening the bottom of said mold cavity during a second phase of glass casting.

10. A mold according to claim 9 further comprising a base plate having a drainage well therein, wherein the mold is movable on said base plate from a position during the first molding phase where the bottom of the mold is closed, to a second position over said drainage well.
